(19) United States
(12) Patent Application Publication
(10) Pub. No.: US 2022/0064014 A1
(43) Pub. Date: Mar. 3, 2022

(54) THERMAL SPRAY MATERIAL AND METHOD FOR FORMING THERMAL SPRAYED COATING USING SAME

(71) Applicant: FUJIMI INCORPORATED, Kiyosu-shi (JP)

(72) Inventors: Takaya MASUDA, Kiyosu-shi (JP); Kazuya SUGIMURA, Kiyosu-shi (JP); Hiroyuki IBE, Kiyosu-shi (JP)

(73) Assignee: FUJIMI INCORPORATED, Kiyosu-shi (JP)

(21) Appl. No.: 17/393,663

(22) Filed: Aug. 4, 2021

(30) Foreign Application Priority Data
Aug. 28, 2020 (JP) 2020-144978

(51) Int. Cl. C01F 17/259; C23C 4/04

(52) U.S. Cl. CPC C01F 17/259; C23C 4/04; C01P 2004/61; C01P 2002/72; C01P 2004/62; C01P 2004/03

(57) ABSTRACT

A thermal spray material that enables a thermal sprayed coating, which is capable of exhibiting the same performances as those of the related art, to be obtained more easily than the related art, and a method for forming a thermal sprayed coating using the thermal spray material are provided.

A thermal spray material which for forming a thermal sprayed coating containing a rare-earth oxyhalide includes a rare-earth halide powder and a rare-earth oxide powder.

### BACKGROUND OF THE INVENTION

### Field of the Invention

The present invention relates to a thermal spray material for forming a thermal sprayed coating containing a rare-earth oxyhalide, and a method for forming a thermal sprayed coating using the thermal spray material.

### Description of the Related Art

Thermal sprayed coatings formed by thermal spraying a thermal spray material onto a base material are used for various usage applications according to material characteristics of the thermal spray material. For example, in a case where a thermal sprayed coating, for which rare-earth oxyhalides such as yttrium oxyfluorides are used as a thermal spray material, is exposed to plasma, the thermal sprayed coating exhibits high plasma erosion resistance (etching resistance, corrosion resistance, and the like), and therefore is used as a protective coating for parts in semiconductor device manufacturing equipment that is processed by plasma.

In a case of forming such a thermal sprayed coating of a rare-earth oxyhalide, in the related art, a thermal spray material of a rare-earth oxyhalide is manufactured, and the thermal spray material is thermal sprayed, and thereby a thermal sprayed coating of a rare-earth oxyhalide is formed. That is, for example, a thermal spray material of a powdered rare-earth oxyhalide is manufactured by mixing, granulating, and degreasing a rare-earth oxide and a rare-earth halide which are raw materials, and then performing firing by heat treatment, crush, and classification; or a slurry-like thermal spray material is manufactured by further grinding the powdered rare-earth oxyhalide and dispersing it in a dispersion medium (refer to, for example, PTL 1 below).

### CITATION LIST

### Patent Literature

PTL 1: JP 2017-061738 A

### SUMMARY OF THE INVENTION

However, it takes a lot of time and effort since the conventional thermal spray material as described above is manufactured in a powdered form by mixing, granulating, and firing by heating raw materials, and then performing crush and classification, or is manufactured in a slurry form by further performing grinding and dispersion in a dispersion medium.

Accordingly, an object of the present invention to provide a thermal spray material that enables a thermal sprayed coating, which contains a rare-earth oxyhalide, to be obtained easily, and a method for forming a thermal sprayed coating using the thermal spray material.

A thermal spray material according to the present invention for achieving the aforementioned object is a thermal spray material for forming a thermal sprayed coating containing a rare-earth oxyhalide and is characterized by including a rare-earth halide powder and a rare-earth oxide powder.

Furthermore, a method for forming a thermal sprayed coating according to the present invention for achieving the aforementioned object is characterized by including thermal spraying the aforementioned thermal spray material onto a base material to form the thermal sprayed coating containing the rare-earth oxyhalide.

According to a thermal spray material according to the present invention and a method for forming a thermal sprayed coating using the same, it is possible to easily obtain a thermal sprayed coating containing a rare-earth oxyhalide.

### BRIEF DESCRIPTION OF THE DRAWINGS

FIG. 1 is a scanning electron microscope photograph of a thermal sprayed coating B1 of Examples;

FIG. 2 is a scanning electron microscope photograph of a thermal sprayed coating B2 of Examples;

FIG. 3 is a scanning electron microscope photograph of a thermal sprayed coating B3 of Examples;

FIG. 4 is a scanning electron microscope photograph of a thermal sprayed coating B4 of Examples;

FIG. 5 is a scanning electron microscope photograph of a thermal sprayed coating B5 of Examples;

FIG. 6 is a scanning electron microscope photograph of a thermal sprayed coating B6a of Examples;

FIG. 7 is a scanning electron microscope photograph of a thermal sprayed coating B6b of Examples;

FIG. 8 is a scanning electron microscope photograph of a thermal sprayed coating B6c of Examples;

FIG. 9 is a scanning electron microscope photograph of a thermal sprayed coating B7 of Examples;

FIG. 10 is a scanning electron microscope photograph of a thermal sprayed coating B8 of Examples;

FIG. 11 is a scanning electron microscope photograph of a thermal sprayed coating B9 of Examples;

FIG. 12 is a graph illustrating results of X-ray diffraction analysis of the thermal sprayed coating B1 of Example;

FIG. 13 is a graph illustrating results of X-ray diffraction analysis of the thermal sprayed coating B2 of Example;

FIG. 14 is a graph illustrating results of X-ray diffraction analysis of the thermal sprayed coating B3 of Example;

FIG. 15 is a graph illustrating results of X-ray diffraction analysis of the thermal sprayed coating B4 of Example;

FIG. 16 is a graph illustrating results of X-ray diffraction analysis of the thermal sprayed coating B5 of Example;

FIG. 17 is a graph illustrating results of X-ray diffraction analysis of the thermal sprayed coating B6a of Example;

FIG. 18 is a graph illustrating results of X-ray diffraction analysis of the thermal sprayed coating B6b of Example;

FIG. 19 is a graph illustrating results of X-ray diffraction analysis of the thermal sprayed coating B6c of Example;

FIG. 20 is a graph illustrating results of X-ray diffraction analysis of the thermal sprayed coating B7 of Example;

FIG. 21 is a graph illustrating results of X-ray diffraction analysis of the thermal sprayed coating B8 of Example; and

FIG. 22 is a graph illustrating results of X-ray diffraction analysis of the thermal sprayed coating B9 of Example.

### DESCRIPTION OF THE PREFERRED EMBODIMENTS

Embodiments of a thermal spray material according to the present invention and a method for forming a thermal sprayed coating using the same will be described, but the present invention is not limited to the embodiments described below.

### Main Embodiment

A main embodiment of the thermal spray material according to the present invention and a method for forming a thermal sprayed coating using the same will be described.

A thermal spray material according to the present embodiment is a thermal spray material for forming a thermal sprayed coating containing a rare-earth oxyhalide and includes a rare-earth halide powder and a rare-earth oxide powder.

Examples of rare-earth halide powders include powders such as yttrium fluoride (YF₃) and yttrium chloride (YCl₃), where yttrium fluoride (YF₃) is preferable. An average particle diameter (D₅₀) of the rare-earth halide powder is preferably 0.3 μm or more and 3 μm or less. The reason for this is as follows: when the average particle diameter is less than 0.3 μm, this is not preferable because then it becomes difficult to form a slurry, and when the average particle diameter exceeds 3 μm, this is not preferable because then the composition of a coating formed by thermal spraying is likely to become non-uniform.

Examples of rare-earth oxide powders include yttrium oxide (Y₂O₃) and the like. An average particle diameter (D₅₀) of the rare-earth oxide powder is preferably 0.05 μm or more and 3 μm or less. The reason for this is as follows: when the average particle diameter is less than 0.05 μm, this is not preferable because then it becomes difficult to dissolve an agglomerated powder, and when the average particle diameter exceeds 3 μm, this is not preferable because then the yttrium oxide (Y₂O₃) phase is likely to locally present in a thermal sprayed coating, and plasma resistance of the thermal sprayed coating is likely to decrease.

Furthermore, when an average particle diameter (D₅₀) of the rare-earth oxide powder is equal to or less than an average particle diameter (D₅₀) of the rare-earth halide powder, this is preferable because then the rare-earth oxide powder and the rare-earth halide powder easily react, and thereby a rare-earth oxyhalide is easily formed.

The above-mentioned “average particle diameter (D₅₀)” is a particle size at an integrated value of 50% (integrated 50% particle size) in the volume-based particle size distribution measured by a particle size distribution measuring device based on a laser diffraction/light scattering method (for example, “Mastersizer 3000 (product name)” manufactured by Malvern Panalytical Ltd., United Kingdom, and the like).

Furthermore, in the thermal spray material according to the present embodiment, a proportion of a content (mass) of the rare-earth oxide powder with respect to a content (mass) of the rare-earth halide powder is preferably 0.1 or more and 0.5 or less. The reason for this is as follows: when the proportion is less than 0.1, this is not preferable because then the yttrium oxyfluoride (YOF) phase formed in a thermal sprayed coating is excessively small, and it becomes difficult to sufficiently improve plasma resistance of the thermal sprayed coating, and when the proportion exceeds 0.5, this is not preferable because then the yttrium oxide (Y₂O₃) phase is likely to locally present in a thermal sprayed coating, and plasma resistance of the thermal sprayed coating is likely to decrease.

In particular, when yttrium fluoride (YF₃) and yttrium oxide (Y₂O₃) are used as raw materials, and when yttrium fluoride (YF₃) and yttrium oxide (Y₂O₃) are mixed so that a ratio of an yttrium element, an oxygen element, and a fluorine element (Y:O:F) is 1:1:1 in a molar ratio, this is highly preferable because then a thermal sprayed coating easily forms a single phase of YOF.

Furthermore, it is highly preferable that the thermal spray material according to the present embodiment be a slurry in which the rare-earth halide powder and the rare-earth oxide powder are mixed with and dispersed in a dispersion medium. The dispersion medium is not particularly limited as long as it can disperse the powders, and examples thereof include ion exchange water, an alcohol solution, and a mixed solution of ion exchange water and an alcohol solution.

The slurry is preferably a slurry in which the rare-earth halide powder and the rare-earth oxide powder are mixed with a dispersion medium so that a ratio of the dispersion medium and a total of the rare-earth halide powder and the rare-earth oxide powder is 9:1 to 5:5 (particularly 9:1 to 7:3) in a mass ratio. The reason for this is as follows: when a proportion of the dispersion medium is a smaller value than the above-mentioned ratio range, this is not preferable because then rare-earth halides in the composition of a coating formed by thermal spraying are likely to become excessive, and when a proportion of the dispersion medium is a larger value than the above-mentioned ratio range, this is not preferable because then rare-earth oxides in a coating formed by thermal spraying are likely to remain as a single phase.

The slurry can contain various additives other than the above-described powder in the dispersion medium. For example, it is preferable that a dispersant (anionic type, cationic type, non-ionic type, or the like) and the like be mixed.

By thermal spraying such thermal spray material according to the present embodiment onto a base material, it is possible to form a thermal sprayed coating containing a rare-earth oxyhalide on the base material, and impart environmental barrier properties (typically, plasma erosion resistance) to the base material.

In the present embodiment, it is possible to form a thermal sprayed coating of an yttrium oxyfluoride (YOF) which is a rare-earth oxyhalide by applying yttrium fluorides as a rare-earth halide powder and applying yttrium oxides as a rare-earth oxide powder.

The thermal spray material according to the present embodiment may further contain a powder composed of another compound other than the above-described powders. In a case of a thermal spray material capable of forming a larger amount of yttrium oxyfluorides, this is preferable because then it is possible to form a thermal sprayed coating having extremely excellent plasma erosion resistance since a thermal sprayed coating containing yttrium oxyfluorides as a main component has excellent plasma erosion resistance, particularly erosion resistance with respect to halogen-based plasma.

The base material is not particularly limited as long as it is a material having a material or shape that can withstand thermal spraying of the thermal spray material, and examples thereof include various metals or alloys, and the like. Specific examples thereof include aluminum, aluminum alloy, iron, steel, copper, copper alloy, nickel, nickel alloy, gold, silver, bismuth, manganese, zinc, zinc alloy, and the like.

Among the examples, particularly preferable examples in which a coefficient of thermal expansion is relatively large among widely used metal materials are as follows: steel represented by various SUS materials (so-called stainless steel) and the like; heat-resistant alloys represented by Inconel and the like; low expansion alloys represented by Invar, Kovar, and the like; corrosion-resistant alloys represented by Hastelloy and the like; and aluminum alloys represented by 1000 to 7000 series aluminum alloys, which are useful as a material of lightweight structure and the like, and the like. Examples of base materials made of such materials include a part constituting semiconductor device manufacturing equipment which is a part used in an environment exposed to highly reactive oxygen gas plasma and halogen-based plasma, and the like.

The halogen-based plasma is typically a plasma generated by using a plasma-generating gas containing a halogen-based gas (halogen compound gas). Specific typical examples thereof include a plasma generated by using one kind of halogen-based gases such as fluorine-based gases such as SF₆, CF₄, CHF₃, ClF₃, and HF, chlorine-based gases such as Cl₂, BCl₃, and HCl, and bromine-based gases such as HBr, or by mixing and using two or more kinds thereof, where halogen-based gases are used in a dry etching process when manufacturing semiconductor substrates, and the like. These gases can also be mixed gases with an inert gas such as argon (Ar).

As a method for thermal spraying a thermal spray material according to the present embodiment, it is possible to apply, for example, various known thermal spraying methods such as a plasma thermal spraying method, a high velocity flame thermal spraying method, a flame thermal spraying method, an explosive thermal spraying method, and an aerosol deposition method, where a plasma thermal spraying method is particularly preferable. The plasma thermal spraying method is a method of using a plasma flame as a heat source for softening or melting a thermal spray material.

That is, the plasma thermal spraying method is a coating technique for forming a thermal sprayed coating by generating an arc between electrodes, turning a working gas into a plasma by this arc to eject the plasma from a nozzle as a high-temperature and high-speed plasma jet, and supplying a thermal spray material to this plasma jet to heat and accelerate the thermal spray material, and thereby depositing the thermal spray material onto a base material. Specifically, for example, by a plasma jet at a temperature of about 5,000° C. to 10,000° C. and a speed of about 300 to 600 m/s, the thermal spray material is melted and accelerated to collide with the base material.

In such a plasma thermal spraying method, there are atmospheric plasma spraying (APS) that performs thermal spraying in the atmosphere, low pressure plasma spraying (LPS) that performs thermal spraying under reduced pressure below atmospheric pressure, and high pressure plasma spraying (HPS) that performs thermal spraying under pressure higher than atmospheric pressure, and any of them can be applied.

The thermal sprayed coating according to the present embodiment which is formed on a base material in the above-described manner can exhibit the same performances as those of a conventional thermal sprayed coating formed using a powdered thermal spray material of a rare-earth oxyhalide in which a rare-earth oxide powder and a rare-earth halide powder, which are raw materials, are mixed and granulated, fired by heating, and then crushed and classified, and a slurry-like thermal spray material in which the rare-earth oxyhalide is further ground and dispersed in a dispersion medium.

That is, in the related art, a rare-earth oxide powder and a rare-earth halide powder, which are raw materials, are mixed and fired prior to thermal spraying to obtain a thermal spray material of a rare-earth oxyhalide, and thereafter, this thermal spray material is thermal sprayed to form a thermal sprayed coating of a rare-earth oxyhalide on a base material, whereas in the present embodiment, a thermal spray material in which a rare-earth oxide powder and a rare-earth halide powder are mixed is thermal sprayed to form a thermal sprayed coating of a rare-earth oxyhalide on a base material while generating the rare-earth oxyhalide by heat from the thermal spraying.

Therefore, the thermal spray material according to the present embodiment can be manufactured with lesser time and effort than the conventional thermal spray material.

Accordingly, according to the present embodiment, the thermal sprayed coating of a rare-earth oxyhalide can be obtained more easily than the related art.

### EXAMPLES

Examples of the thermal spray material according to the present invention and the method for forming the thermal sprayed coating using the same will be described, but the present invention is not limited to specific examples described below.

[Production of Thermal Spray Material]

<Thermal Spray Material A1>

An yttrium fluoride (YF₃) powder having an average particle diameter (D₅₀) of 3 μm and an yttrium oxide (Y₂O₃) powder having an average particle diameter (D₅₀) of 3 μm were added into ion exchange water as a dispersion medium so that a proportion of a mass of yttrium oxide (Y₂O₃) with respect to a mass of yttrium fluoride (YF₃) was 0.429 (YF₃:Y₂O₃=7:3). Furthermore, an anionic dispersant as an additive was added into and mixed with the ion exchange water under stirring so that a proportion of the anionic dispersant with respect to a total mass of the yttrium fluoride (YF₃) powder and the yttrium oxide (Y₂O₃) powder was 0.05% by mass. Thereby a slurry-like thermal spray material A1 was produced. A mixing ratio of the dispersion medium (ion exchange water), and the yttrium fluoride (YF₃) powder and the yttrium oxide (Y₂O₃) powder was set to 7:3 in a mass ratio.

<Thermal Spray Material A2>

A slurry-like thermal spray material A2 was produced under the same conditions as those for the thermal spray material Al except that an yttrium fluoride (YF₃) powder and an yttrium oxide (Y₂O₃) powder were added into ion exchange water so that a proportion of a mass of yttrium oxide (Y₂O₃) with respect to a mass of yttrium fluoride (YF₃) was 0.250 (YF₃:Y₂O₃=8:2).

<Thermal Spray Material A3>

A slurry-like thermal spray material A3 was produced under the same conditions as those for the thermal spray material Al except that an yttrium fluoride (YF₃) powder and an yttrium oxide (Y₂O₃) powder were added into ion exchange water so that a proportion of a mass of yttrium oxide (Y₂O₃) with respect to a mass of yttrium fluoride (YF₃) was 0.111 (YF₃:Y₂O₃=9:1).

<Thermal Spray Material A4>

A slurry-like thermal spray material A4 was produced under the same conditions as those for the thermal spray material Al except that an yttrium oxide (Y₂O₃) powder having an average particle diameter (D₅₀) of 1 μm was applied.

<Thermal Spray Material A5>

A slurry-like thermal spray material A5 was produced under the same conditions as those for the thermal spray material A1 except that an yttrium oxide (Y₂O₃) powder having an average particle diameter (D₅₀) of 0.5 μm was applied.

<Thermal Spray Material A622

A slurry-like thermal spray material A6 was produced under the same conditions as those for the thermal spray material Al except that an yttrium fluoride (YF₃) powder having an average particle diameter (D₅₀) of 1 μm, and an yttrium oxide (Y₂O₃) powder which had an average particle diameter (D₅₀) of 0.5 μm and had been subjected to dispersion treatment with a pot mill in advance were applied, and an anionic dispersant was added into ion exchange water so that a proportion of the anionic dispersant with respect to a total mass of the yttrium fluoride (YF₃) powder and the yttrium oxide (Y₂O₃) powder was 0.3% by mass.

<Thermal Spray Material A7>

A slurry-like thermal spray material A7 was produced under the same conditions as those for the thermal spray material A6 except that an alcohol solution was applied as a dispersion medium, and a non-ionic dispersant as an additive was added into the alcohol solution so that a proportion of the non-ionic dispersant with respect to a total mass of an yttrium fluoride (YF₃) powder and an yttrium oxide (Y₂O₃) powder was 1.0% by mass.

<Thermal Spray Material A8>

A slurry-like thermal spray material A8 was produced under the same conditions as those for the thermal spray material A7 except that a solution in which an alcohol solution and ion exchange water were mixed so that a ratio of the alcohol solution and the ion exchange water was 8:2 in a volume ratio (an alcohol solution containing 20% by volume of ion exchange water) was applied as a dispersion medium, and an anionic dispersant as an additive was further added so that a proportion of the anionic dispersant with respect to a total mass of an yttrium fluoride (YF₃) powder and an yttrium oxide (Y₂O₃) powder was 0.6% by mass.

<Thermal Spray Material A9>

A slurry-like thermal spray material A9 was produced under the same conditions as those for the thermal spray material A7 except that a solution in which an alcohol solution and ion exchange water were mixed so that a ratio of the alcohol solution and the ion exchange water was 2:8 in a volume ratio (ion exchange water containing 20% by volume of the alcohol solution) was applied as a dispersion medium, and an anionic dispersant as an additive was further added so that a proportion of the anionic dispersant with respect to a total mass of an yttrium fluoride (YF₃) powder and an yttrium oxide (Y₂O₃) powder was 0.3% by mass.

TABLE 1

| | | | | | Dispersion | |
|---|---|---|---|---|---|---|
| Thermal spray | YF₃ | Y₂O₃ | Y₂O₃/YF₃ | | medium:(YF₃ + Y₂O₃) | Additive |
| material | D₅₀ (μm) | D₅₀ (μm) | (mass ratio) | Dispersion medium | (mass ratio) | (dispersant) |
| A1 | 3 | 3 | 0.429 | Ion exchange water | 7:3 | Anionic type 0.05 wt % |
| A2 | 3 | 3 | 0.250 | Ion exchange water | 7:3 | Anionic type 0.05 wt % |
| A3 | 3 | 3 | 0.111 | Ion exchange water | 7:3 | Anionic type 0.05 wt % |
| A4 | 3 | 1 | 0.429 | Ion exchange water | 7:3 | Anionic type 0.05 wt % |
| A5 | 3 | 0.5 | 0.429 | Ion exchange water | 7:3 | Anionic type 0.05 wt % |
| A6 | 1 | 0.5 | 0.429 | Ion exchange water | 7:3 | Anionic type 0.3 wt % |
| A7 | 1 | 0.5 | 0.429 | Alcohol solution | 7:3 | Non-ionic type 1.0 wt % |
| A8 | 1 | 0.5 | 0.429 | Alcohol solution 80 | 7:3 | Non-ionic type 1.0 wt % + anionic |
| | | | | vol % + water 20 vol % | | type 0.6 wt % |
| A9 | 1 | 0.5 | 0.429 | Alcohol solution 20 | 7:3 | Non-ionic type 1.0 wt % + anionic |
| | | | | vol % + water 80 vol % | | type 0.3 wt % |

[Formation of Thermal Sprayed Coating]

The above-described thermal spray materials A1 to A9 were used to be plasma thermal sprayed onto a base material (material: Al alloy, size: 50 mm×70 mm×5 mm) by a plasma thermal spraying device (“100HE (model number)” manufactured by Progressive Surface, United States) under conditions shown in Table 2 below. Thereby, thermal sprayed coatings B1 to B5, B6a to B6c, and B7 to B9 each having a thickness of about 100 μm were formed.

TABLE 2

| | | | | | Thermal | | | | | |
|---|---|---|---|---|---|---|---|---|---|---|
| Thermal | | | | | spraying | Traversal | | | | |
| sprayed | Thermal spray | | Nozzle | Output | distance | velocity | Gas flow volume (slm) | | | |
| coating | material | HW | (inch) | (kW) | (mm) | (mm/sec) | Ar | N₂ | H₂ | Total |
| B1 | Al | Std | 0.375 | 105 | 106 | 1500 | 180 | 70 | 70 | 320 |
| B2 | A2 | Std | 0.375 | 105 | 106 | 1500 | 180 | 70 | 70 | 320 |
| B3 | A3 | Std | 0.375 | 105 | 106 | 1500 | 180 | 70 | 70 | 320 |
| B4 | A4 | Std | 0.375 | 105 | 106 | 1500 | 180 | 70 | 70 | 320 |
| B5 | A5 | Std | 0.375 | 105 | 106 | 1500 | 180 | 70 | 70 | 320 |
| B6a | A6 | Std | 0.375 | 105 | 106 | 1500 | 180 | 70 | 70 | 320 |
| B6b | A6 | Std | 0.375 | 105 | 106 | 1500 | 168.8 | 65.6 | 65.6 | 300 |
| B6c | A6 | Std | 0.375 | 105 | 106 | 1500 | 158 | 61 | 61 | 280 |
| B7 | A7 | Std | 0.375 | 105 | 106 | 1500 | 180 | 70 | 70 | 320 |
| B8 | A8 | Std | 0.375 | 105 | 106 | 1500 | 180 | 70 | 70 | 320 |
| B9 | A9 | Std | 0.375 | 105 | 106 | 1500 | 180 | 70 | 70 | 320 |

[Evaluation Method]

<Scanning Electron Microscope (SEM)>

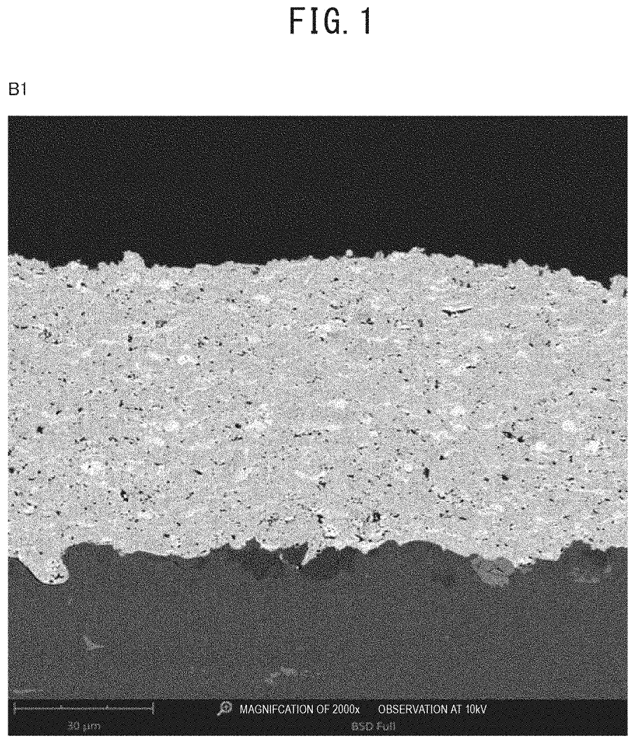

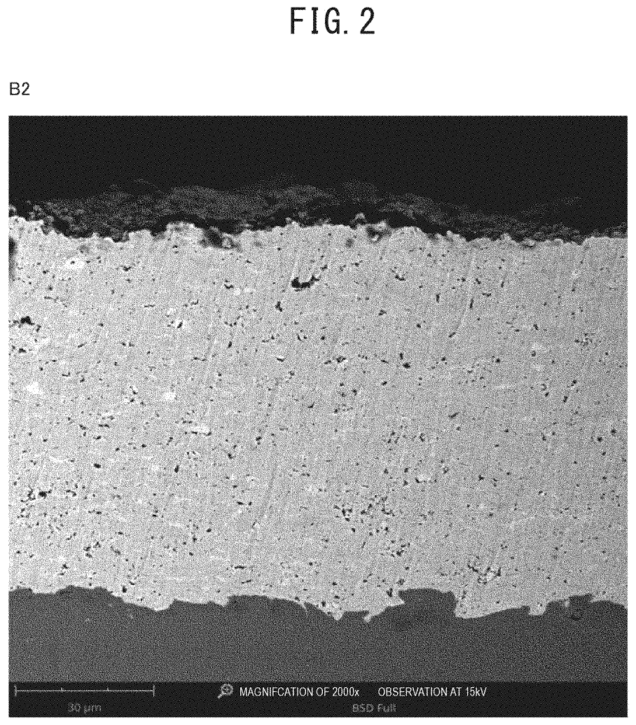

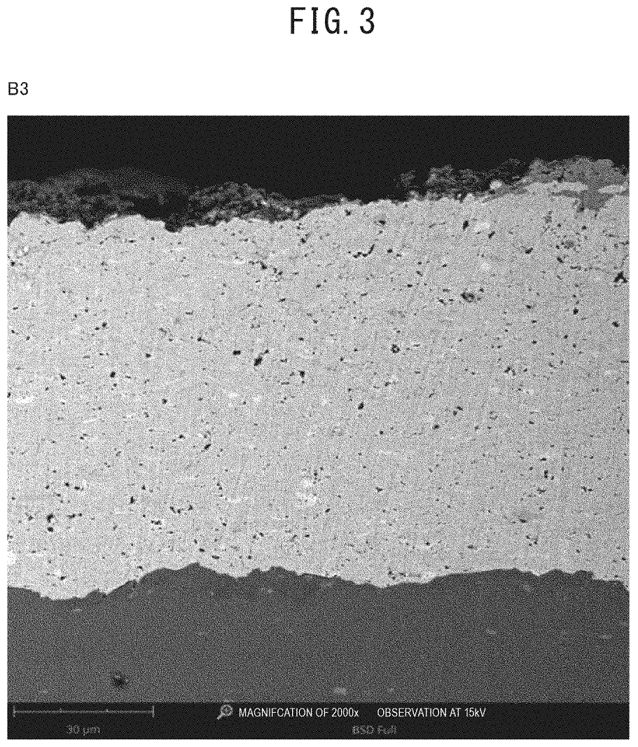

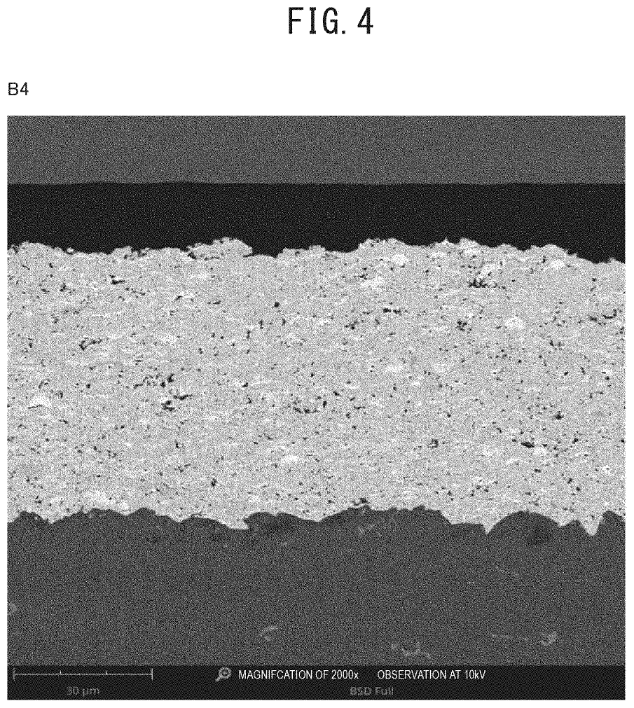

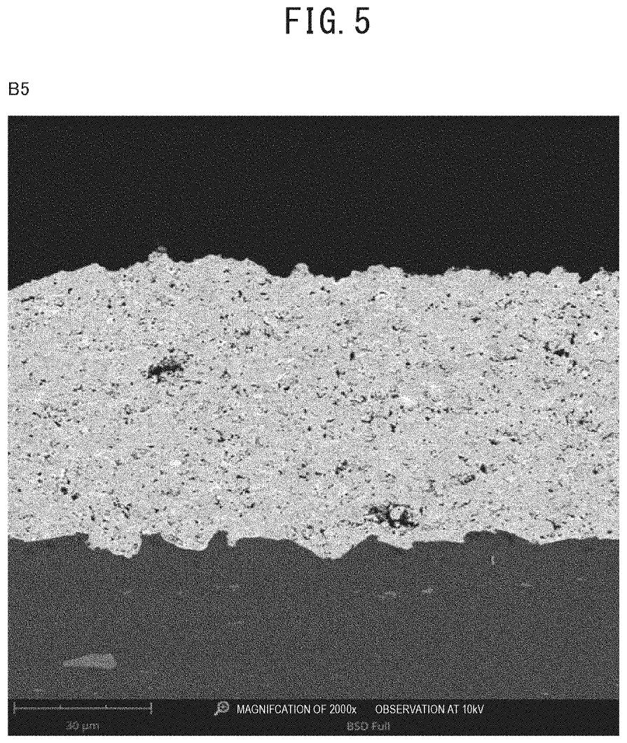

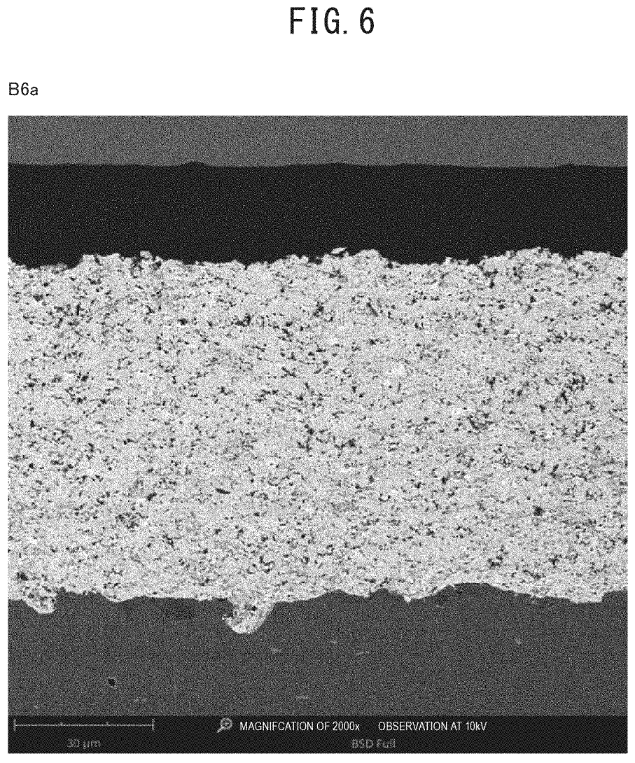

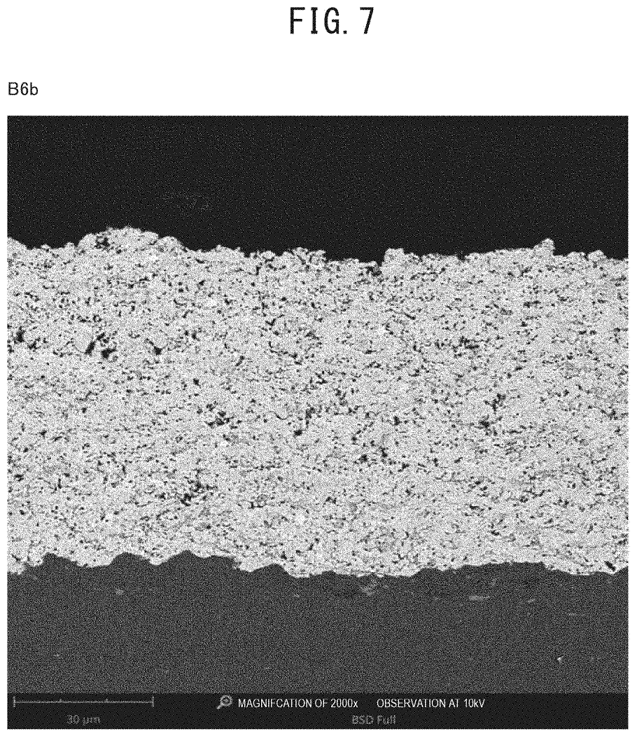

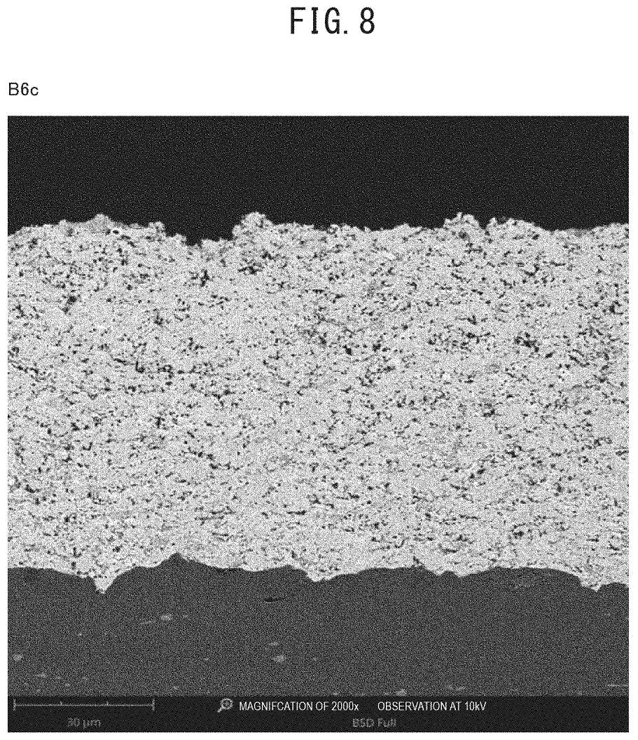

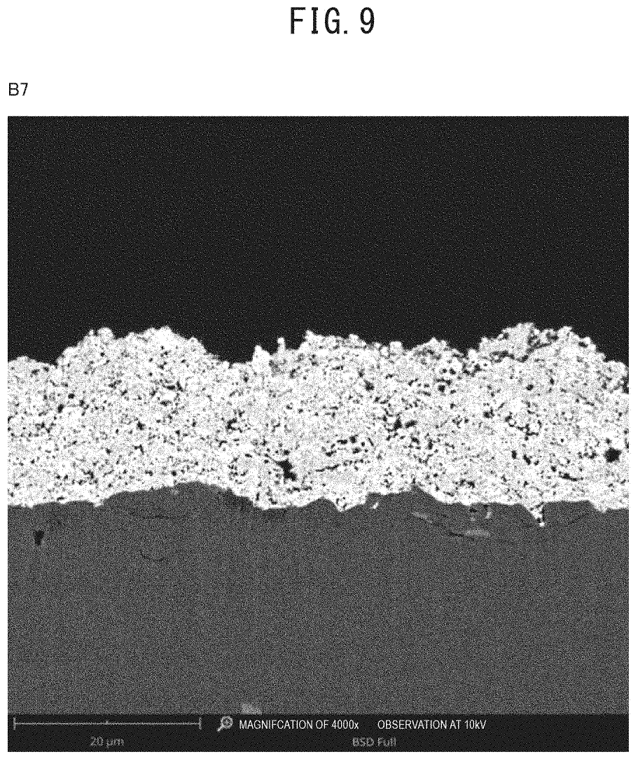

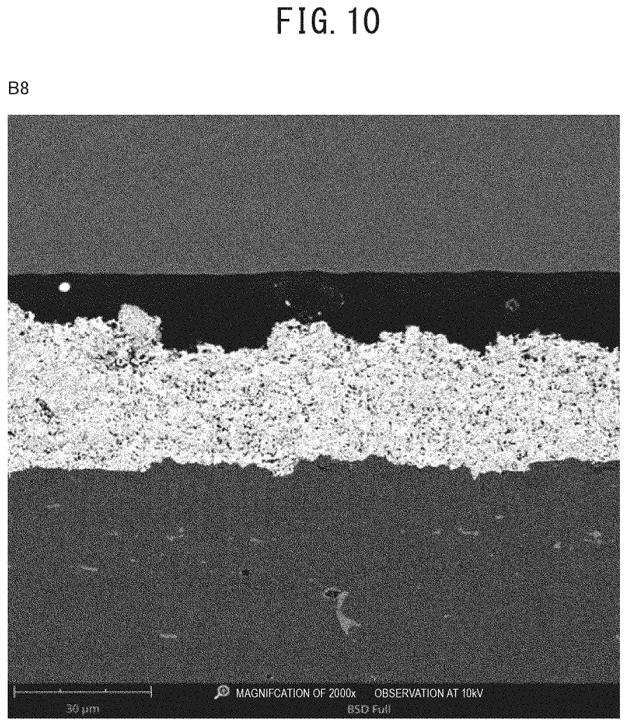

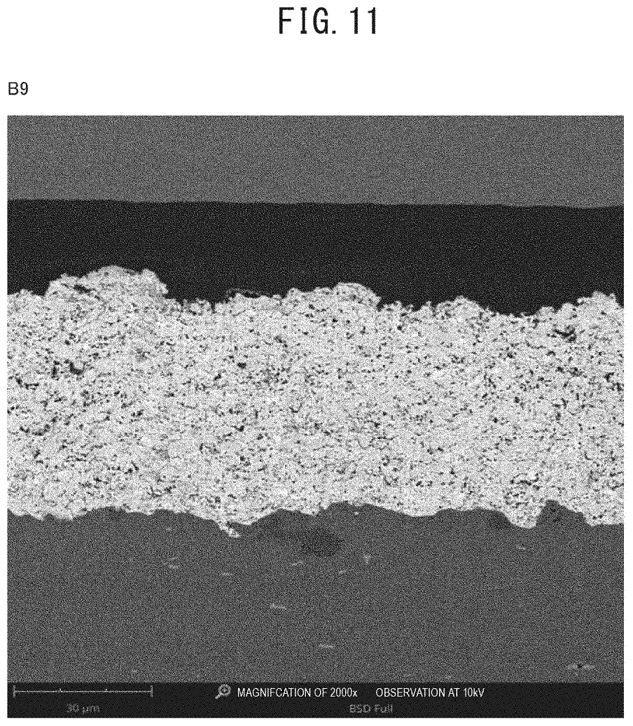

The thermal sprayed coatings B1 to B5, B6a to B6c, and B7 to B9 were cut out with a cutting machine. Thereafter, cross sections thereof were processed with a “Cross Section Polisher (registered trademark)” manufactured by JEOL Ltd. to create a sample for observation. Then, a reflected electron image of the cross section was photographed (acceleration voltage: 10 kV) using an SEM (“Phenom ProX (product name)” manufactured by Phenom-World B.V. in the Netherlands). The results are shown in FIGS. 1 to 11.

<X-Ray Diffraction (XRD) Analysis>

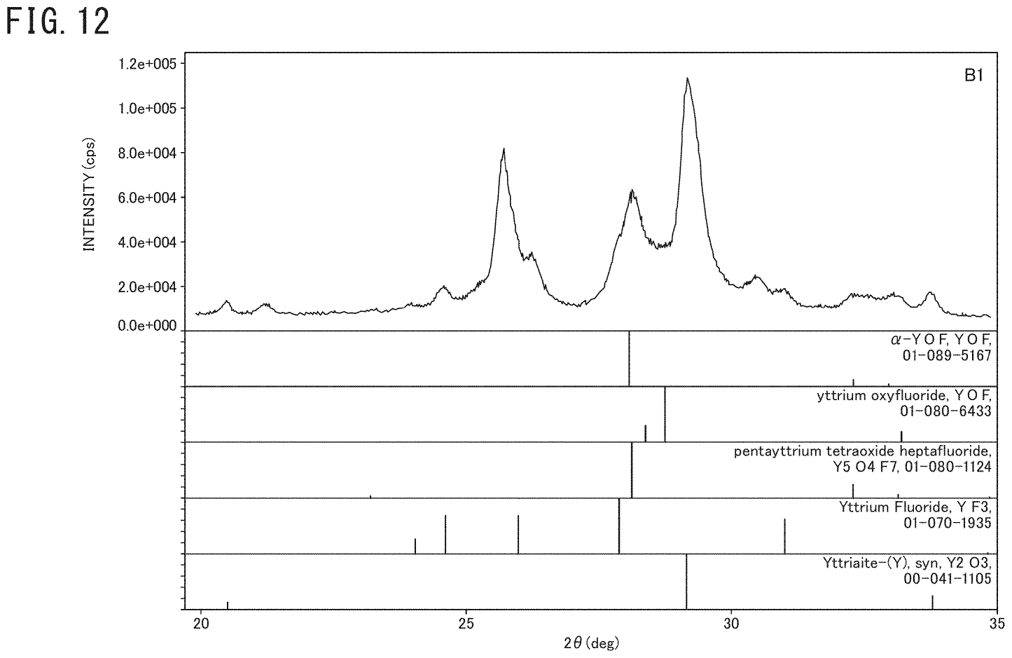

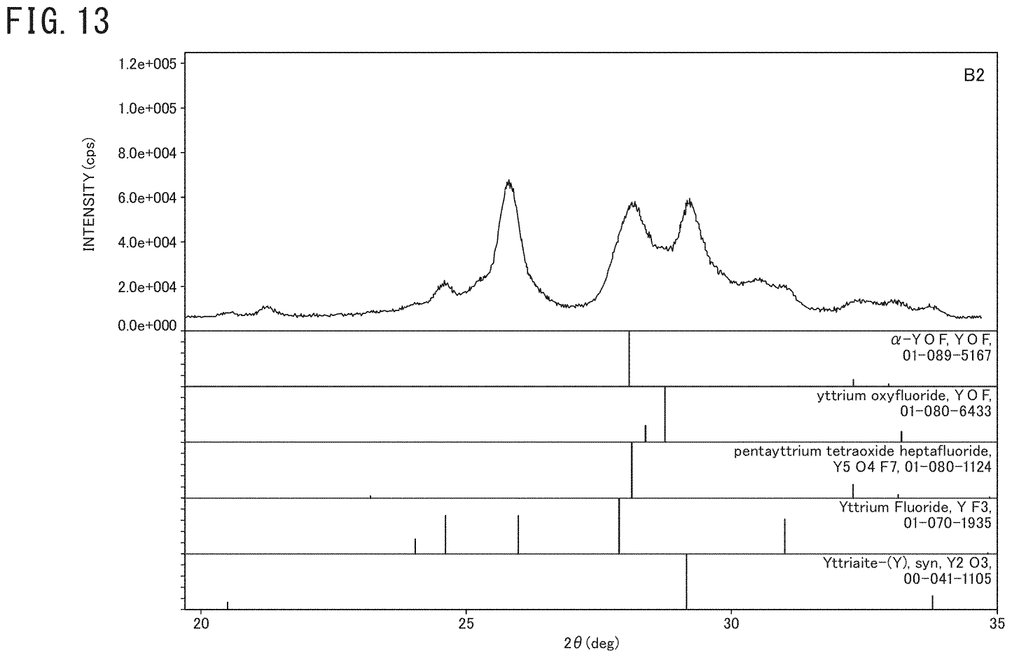

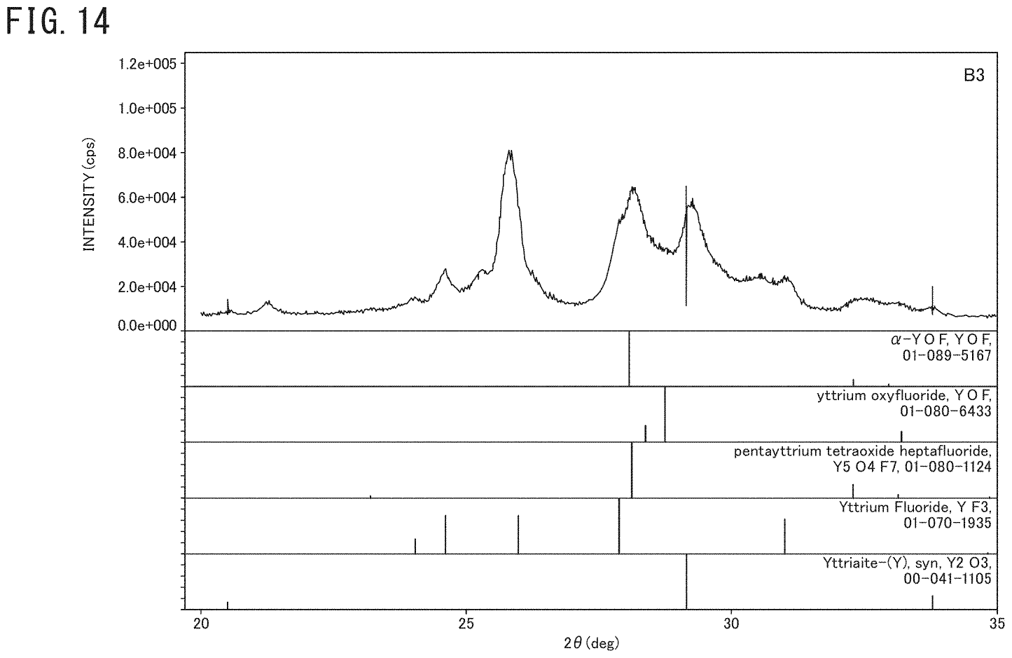

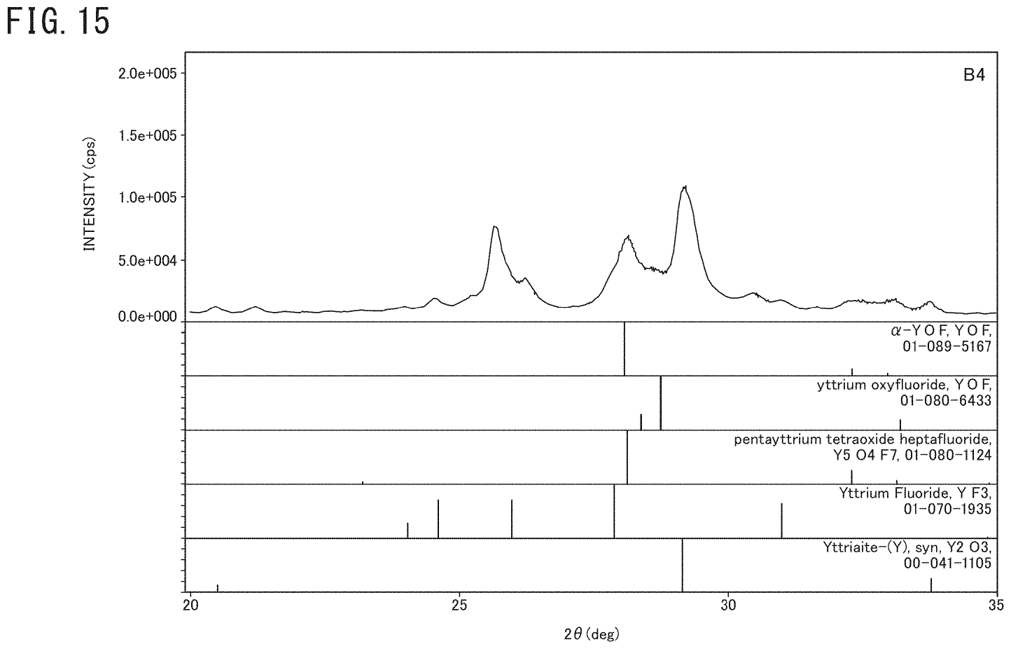

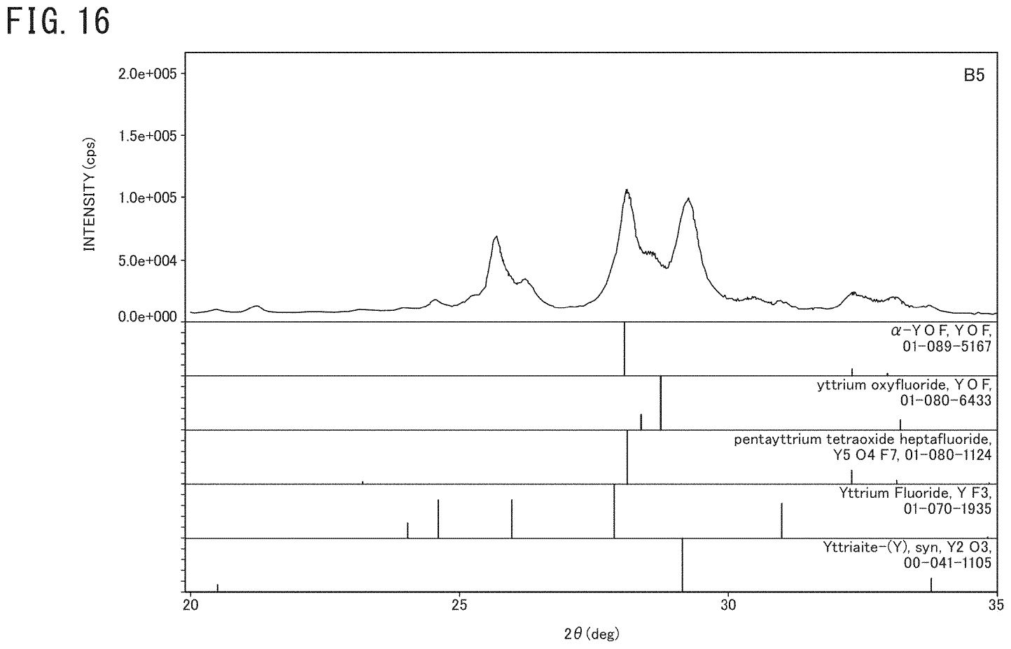

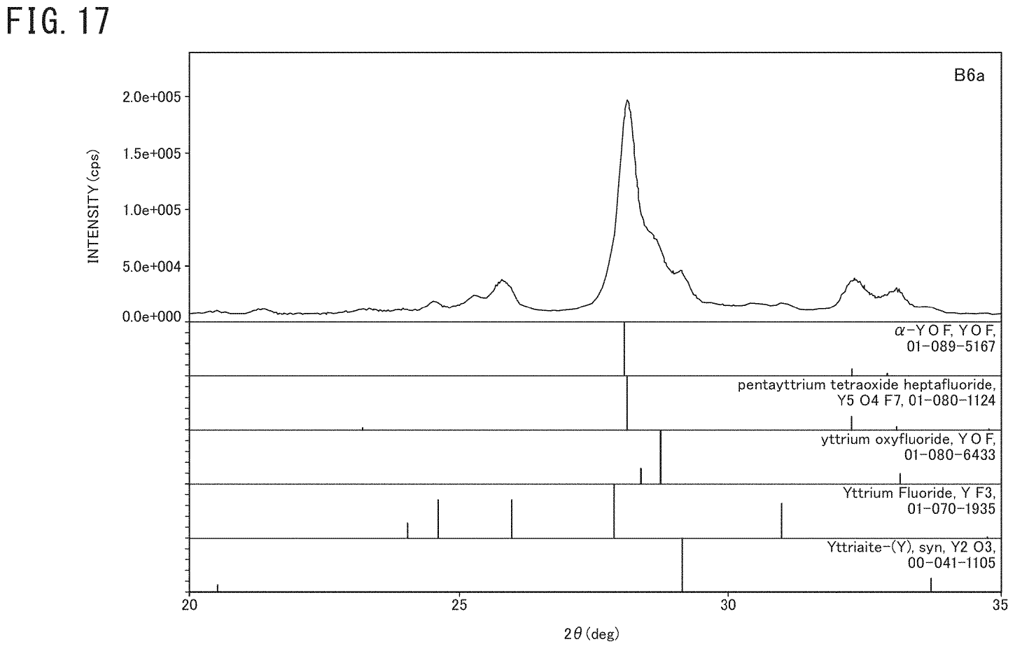

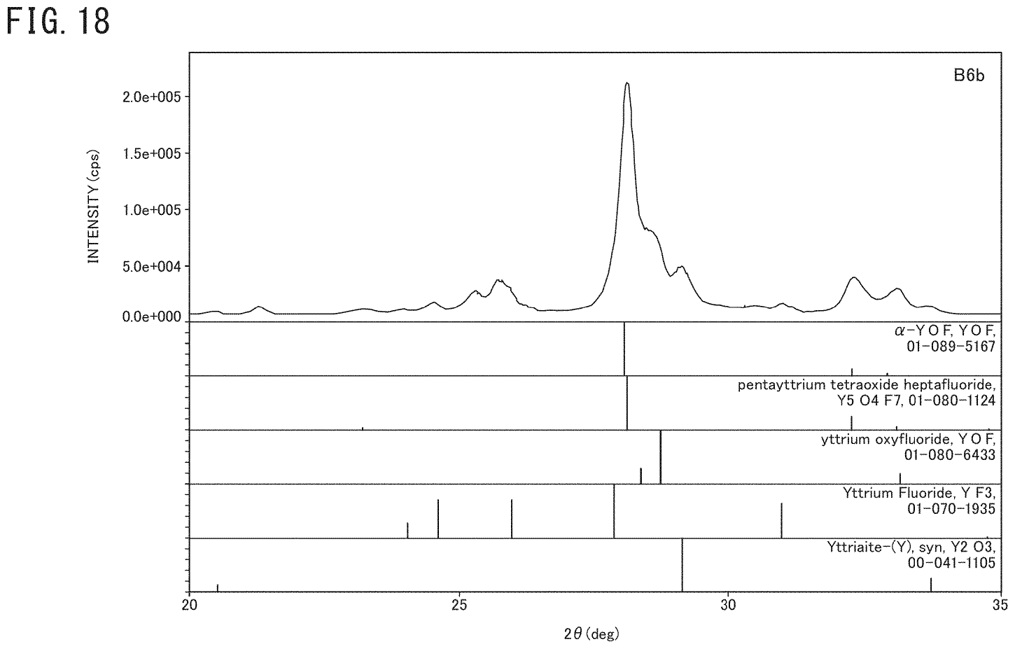

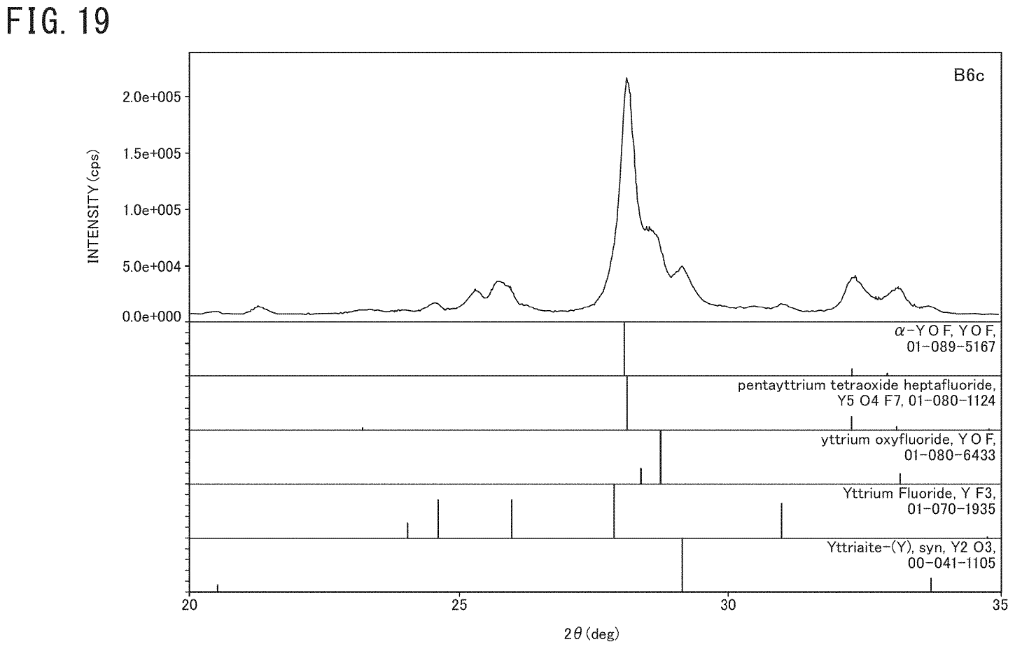

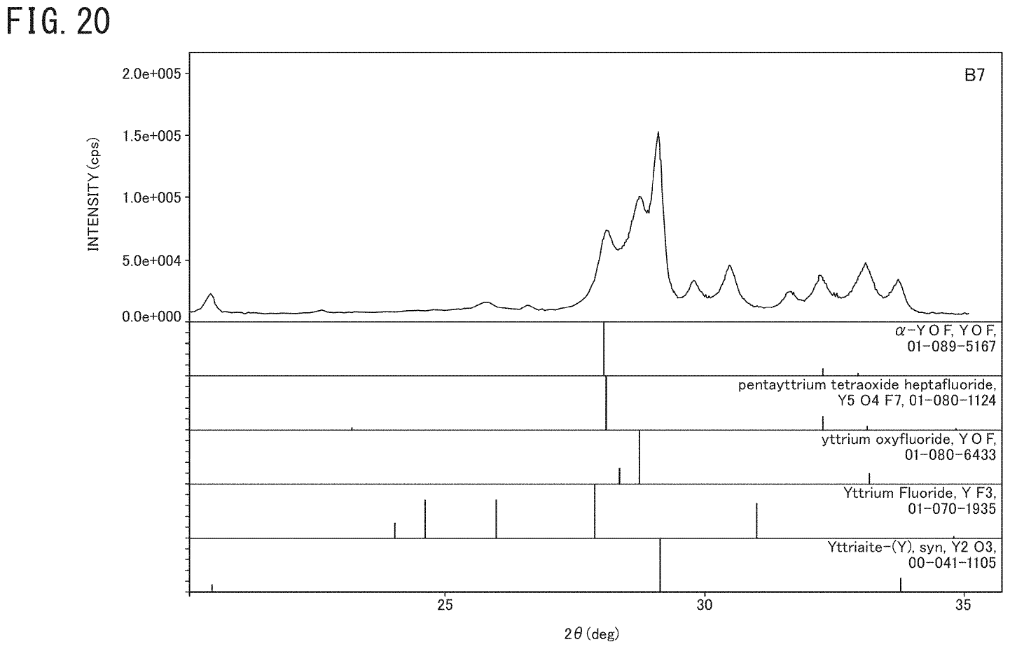

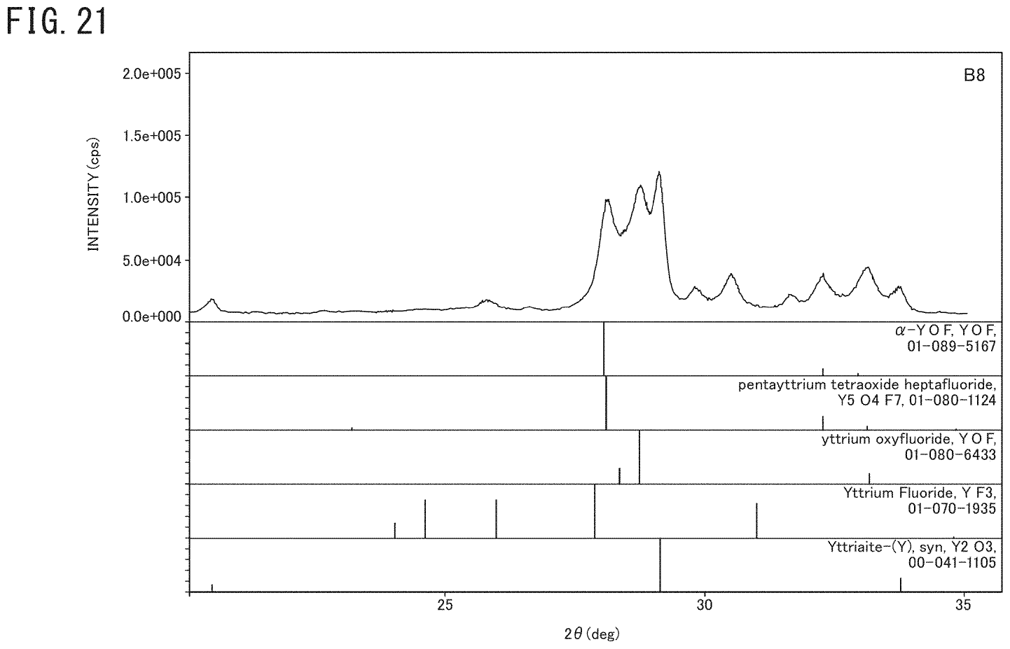

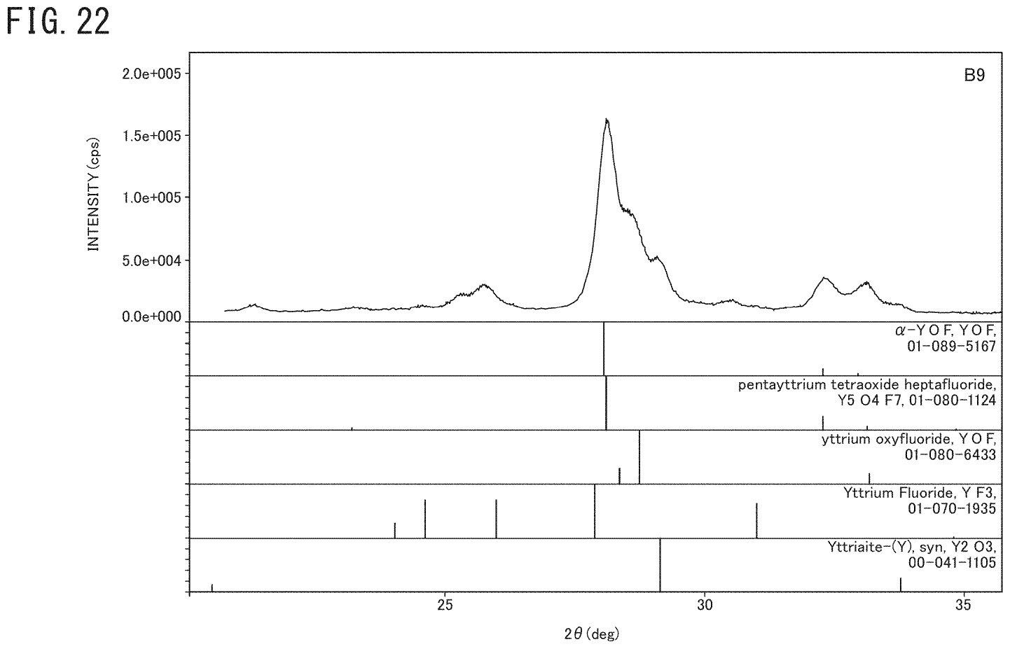

XRD analysis was performed on the thermal sprayed coatings B1 to B5, B6a to B6c, and B7 to B9 in a state of being thermal sprayed and without being polished or the like (start angle: 20°, end angle: 35°) using an XRD analyzer (“Ultima IV (product name)” manufactured by Rigaku Corporation). The results are shown in FIGS. 12 to 22 and Table 3.

[Evaluation Results]

The evaluation of the thermal sprayed coatings B1 to B5, B6a to B6c, and B7 to B9 based on the results of the SEM and the X-ray diffraction analysis is shown in Table 3 below. In Table 3, “A” indicates an excellent evaluation, “B” indicates a favorable evaluation, “C” indicates an applicable evaluation, and “D” indicates an inapplicable evaluation.

TABLE 3

| | XRD | | | | | | |
|---|---|---|---|---|---|---|---|
| Thermal | YOF | | Y₂O₃ | | | YOF/Y₂O₃ | |
| sprayed | | Relative | | Relative | YOF:Y₂O₃ | Strength | |
| coating | Angle | strength | Angle | strength | Strength ratio | proportion | Evaluation |
| B1 | 28.232 | 56 | 29.276 | 100 | 35.9:64.1 | 0.56 | C |
| B2 | 28.441 | 99 | 29.509 | 100 | 49.7:50.3 | 0.99 | B |
| B3 | 28.155 | 100 | 29.263 | 93 | 51.8:48.2 | 1.08 | B |
| B4 | 28.139 | 65 | 29.205 | 100 | 39.4:60.6 | 0.65 | C |
| B5 | 28.969 | 100 | — | 0 | 100:0 | ∞ | A |
| B6a | 28.076 | 100 | — | 0 | 100:0 | ∞ | A |
| B6b | 28.119 | 100 | — | 0 | 100:0 | ∞ | A |
| B6c | 28.109 | 100 | — | 0 | 100:0 | ∞ | A |
| B7 | 28.034 | 100 | — | 0 | 100:0 | ∞ | A |
| B8 | 28.378 | 100 | — | 0 | 100:0 | ∞ | A |
| B9 | 28.031 | 100 | — | 0 | 100:0 | ∞ | A |

As can be seen from FIGS. 1 to 11, all of the thermal sprayed coating B1 to B5, B6a to B6c, and B7 to B9 were dense coatings, and were not evaluated as “D” (inapplicable) as shown in Table 3.

Furthermore, as can be seen from Table 3, for the thermal sprayed coatings B1 and B4 in which an average particle diameter of YF₃ was relatively large (3 μm) and a proportion of Y₂O₃ was relatively large (Y₂O₃/YF₃=0.492), the evaluation was “C” (applicable) because a strength proportion of YOF/Y₂O₃ from XRD analysis was relatively low.

Furthermore, for the thermal sprayed coatings B2 and B3 in which an average particle diameter of YF₃ was relatively large (3 μm) but a proportion of Y₂O₃ was relatively small (Y₂O₃/YF₃=0.111 to 0.250), the evaluation was “B” (favorable) because a strength proportion of YOF/Y₂O₃ from XRD analysis was a moderate level.

Furthermore, for the thermal sprayed coatings B5, B6a to B6c, and B7 to B9 in which an average particle diameter of Y₂O₃ was relatively small (0.5 μm) and a proportion of Y₂O₃ was relatively large (Y₂O₃/YF₃=0.492), the evaluation was “A” (excellent) because a strength proportion of YOF/Y₂O₃ from XRD analysis was maximum.

Based on the above results, it could be confirmed that according to the present invention, as compared to the related art, it is possible to easily obtain a thermal sprayed coating capable of exhibiting an effect of an equal to or higher level than that of the conventional thermal sprayed coating.

### INDUSTRIAL APPLICABILITY

The thermal spray material according to the present invention and the method for forming a thermal sprayed coating using the same can easily obtain a thermal sprayed coating of a rare-earth oxyhalide, and thus can be extremely beneficially used in industry.

1. A thermal spray material for forming a thermal sprayed coating containing a rare-earth oxyhalide, the thermal spray material comprising:
a rare-earth halide powder; and
a rare-earth oxide powder.

2. The thermal spray material according to claim 1, wherein
an average particle diameter (D₅₀) of the rare-earth oxide powder is equal to or less than an average particle diameter (D₅₀) of the rare-earth halide powder.

3. The thermal spray material according to claim 1, wherein
a proportion of a content (mass) of the rare-earth oxide powder with respect to a content (mass) of the rare-earth halide powder is 0.1 or more and 0.5 or less.

4. The thermal spray material according to claim 1, wherein
an average particle diameter (D₅₀) of the rare-earth halide powder is 0.3 μm or more and 3 μm or less, and
an average particle diameter (D₅₀) of the rare-earth oxide powder is 0.05 μm or more and 3 μm or less.

5. The thermal spray material according to claim 1, wherein
the rare-earth halide powder and the rare-earth oxide powder are mixed with a dispersion medium so that a ratio of the dispersion medium and a total of the rare-earth halide powder and the rare-earth oxide powder is 9:1 to 5:5 in a mass ratio.

6. The thermal spray material according to claim 1, wherein
the rare-earth halide powder is an yttrium fluoride powder, and
the rare-earth oxide powder is an yttrium oxide powder.

7. The thermal spray material according to claim 1, wherein
the thermal spray material is a slurry in which the rare-earth halide powder and the rare-earth oxide powder are mixed with and dispersed in a dispersion medium.

8. The thermal spray material according to claim 7, wherein
the dispersion medium is any one of ion exchange water, an alcohol solution, and a mixed solution of ion exchange water and an alcohol solution.

9. A method for forming a thermal sprayed coating, the method comprising:
thermal spraying the thermal spray material according to claim 1 onto a base material to form the thermal sprayed coating containing the rare-earth oxyhalide on the base material.

10. The thermal spray material according to claim 2, wherein
a proportion of a content (mass) of the rare-earth oxide powder with respect to a content (mass) of the rare-earth halide powder is 0.1 or more and 0.5 or less.

11. The thermal spray material according to claim 2, wherein
an average particle diameter (D₅₀) of the rare-earth halide powder is 0.3 μm or more and 3 μm or less, and
an average particle diameter (D₅₀) of the rare-earth oxide powder is 0.05 μm or more and 3 μm or less.

12. The thermal spray material according to claim 3, wherein
an average particle diameter (D₅₀) of the rare-earth halide powder is 0.3 μm or more and 3 μm or less, and
an average particle diameter (D₅₀) of the rare-earth oxide powder is 0.05 μm or more and 3 μm or less.

13. The thermal spray material according to claim 2, wherein
the rare-earth halide powder and the rare-earth oxide powder are mixed with a dispersion medium so that a ratio of the dispersion medium and a total of the rare-earth halide powder and the rare-earth oxide powder is 9:1 to 5:5 in a mass ratio.

14. The thermal spray material according to claim 3, wherein
the rare-earth halide powder and the rare-earth oxide powder are mixed with a dispersion medium so that a ratio of the dispersion medium and a total of the rare-earth halide powder and the rare-earth oxide powder is 9:1 to 5:5 in a mass ratio.

15. The thermal spray material according to claim 4, wherein
the rare-earth halide powder and the rare-earth oxide powder are mixed with a dispersion medium so that a ratio of the dispersion medium and a total of the rare-earth halide powder and the rare-earth oxide powder is 9:1 to 5:5 in a mass ratio.

16. The thermal spray material according to claim 2, wherein
the rare-earth halide powder is an yttrium fluoride powder, and
the rare-earth oxide powder is an yttrium oxide powder.

17. The thermal spray material according to claim 3, wherein
the rare-earth halide powder is an yttrium fluoride powder, and
the rare-earth oxide powder is an yttrium oxide powder.

18. The thermal spray material according to claim 4, wherein
the rare-earth halide powder is an yttrium fluoride powder, and
the rare-earth oxide powder is an yttrium oxide powder.

19. The thermal spray material according to claim 5, wherein
the rare-earth halide powder is an yttrium fluoride powder, and
the rare-earth oxide powder is an yttrium oxide powder.

20. The thermal spray material according to claim 2, wherein
the thermal spray material is a slurry in which the rare-earth halide powder and the rare-earth oxide powder are mixed with and dispersed in a dispersion medium.
